(19) United States
(12) Patent Application Publication
(10) Pub. No.: US 2018/0157796 A1
(43) Pub. Date: Jun. 7, 2018

(54) METHOD AND SYSTEM FOR MEDICAL DATA PROCESSING FOR GENERATING PERSONALIZED ADVISORY INFORMATION BY A COMPUTING SERVER

(71) Applicant: Conduent Business Services, LLC, Dallas, TX (US)

(72) Inventors: Paridhi Jain, Bangalore (IN); Preethi Raj Raajaratnam, Chennai (IN); Sandya Srivilliputtur Mannarswamy, Bangalore (IN); Shourya Roy, Bangalore (IN)

(21) Appl. No.: 15/368,873

(22) Filed: Dec. 5, 2016

(51) Int. Cl. G06F 19/00; G06F 17/27

(52) U.S. Cl. CPC G06F 19/322; G06F 19/324; G06F 17/2785; G06F 17/2775; G06F 17/271

(57) ABSTRACT

The disclosed embodiments illustrate method and system for medical data processing for generating personalized advisory information. The method includes receiving a request comprising a generic clinical care pathway report and medical data of a patient from a user-computing device. Further, the medical data comprises one or more factors associated with a patient profile and a population segment of the patient. The method further includes extracting one or more influence factors and one or more population segments to generate one or more knowledge bases. The method further includes comparing the one or more factors with the extracted one or more influence factors and the one or more population profiles. The method further includes generating a personalized advisory information. The method further includes rendering the generated personalized advisory information on an interactive user interface of the user-computing device over the communication network for selection by a medical practitioner.

### TECHNICAL FIELD

The presently disclosed embodiments are related, in general, to data processing. More particularly, the presently disclosed embodiments are related to a method and system for medical data processing for generating personalized advisory information by a computing server.

### BACKGROUND

In the healthcare industry, current decade is witnessing a rapid shift from the “volume-based payment model” to the “value-based payment model” for in-hospital treatments. The primary reason for the shift is that in the “volume-based payment model,” there are huge variations in costs of procedures and tests for a special surgical procedure or a disease treatment of a patient. Such variations are due to various factors (such as a population group, geography, age group, and gender of the patient) and do not always result in consistently better health outcomes. Hence the patient loses time, money and health. On the contrary, the “value-based payment model,” under the Population Health Management (PHM) program, ensures effective and enduring health outcomes among various population groups at reasonable costs resulting in low re-admission rates. Such a PHM program uses business intelligence tools to mine patient data thereby providing a comprehensive clinical picture of each patient using evidence-based treatments and techniques. Such PHM programs tune clinical procedures toward special user requirements and population factors.

In certain scenarios, to implement the “value-based payment model” to provide standardized care outcome quality without affecting cost, clinical care pathways are being increasingly integrated into clinical decision support systems of a hospital. Usually, a clinical care pathway is a collection of systematic set of concrete elements associated with the care management protocol for a specific surgical procedure or a disease treatment. However existing clinical care pathways are designed for fee for service model, based on generic evidence using a “one cap fits all patients” approach, and not personalized for a specific patient/population profile. Thus, such clinical care pathways does not hold good for every patient and do not model cost effectiveness of interventions.

In other scenarios, the onus on a physician's judgment to adapt to the clinical care pathway for each patient based on the patient specific factors, may put enormous mental burden on the physician, due to time critical nature of healthcare services. Instead they end up following the generic care pathway which fails to customize the pathway for the specific patient while reducing any treatment variation, leading to poor clinical outcomes and increased costs. On the other hand, personalizing care pathways for patient and population specific factors requires manual editing of care pathways element selection by domain experts, consuming considerable time and cost. Such manual editing depends on the domain knowledge of skilled physicians and is not scalable. This brings forth a need to provide automation tools which can aid the healthcare provider in adapting the clinical care pathways to personalized factors for each individual patient in an efficient manner.

Further limitations and disadvantages of conventional and traditional approaches will become apparent to a person with ordinary skill in the art, through a comparison of described systems with some aspects of the present disclosure, as set forth in the remainder of the present application and with reference to the drawings.

### SUMMARY

According to embodiments illustrated herein, there may be provided a method for medical data processing for generating personalized advisory information by computing server. The method includes receiving, by one or more transceivers in the computing server, a request comprising a generic clinical care pathway report and medical data of a patient from a user-computing device over a communication network. Further, the medical data comprises one or more factors associated with a patient profile and a population segment of the patient. The method further includes extracting, by a data extraction processor in the computing server, one or more influence factors and one or more population segments from one or more data sources based on a plurality of unsupervised data mining techniques to generate one or more knowledge bases. Further, the one or more influence factors and the one or more population profiles may correspond to one or more clinical care pathway elements in the generic clinical care pathway report in the received request. The method further includes comparing, by the one or more processors in the computing server, the one or more factors associated with the patient profile and the population segment of the patient with the extracted one or more influence factors and the one or more population profiles in the generated one or more knowledge bases respectively. The method further includes generating, by an advisory information generation processor in the computing server, based on the comparison, a personalized advisory information comprising a set of choices for the one or more clinical care pathway elements automatically for the patient. Further, the determined set of choices in the personalized advisory information are rendered on an interactive user interface of the user-computing device over the communication network for selection by a medical practitioner.

According to embodiments illustrated herein, there may be provided a system for medical data processing for generating personalized advisory information by computing server. The system includes one or more transceivers in the computing server configured to receive a request comprising a generic clinical care pathway report and medical data of a patient from a user-computing device over a communication network. Further, the medical data comprises one or more factors associated with a patient profile and a population segment of said patient. The system further includes a data extraction processor in the computing server configured to extract one or more influence factors and one or more population segments from one or more data sources based on a plurality of unsupervised data mining techniques to generate one or more knowledge bases. Further, the one or more influence factors and the one or more population profiles may correspond to one or more clinical care pathway elements in the generic clinical care pathway report in the received request. The system further includes one or more processors in the computing server configured to compare the one or more factors associated with the patient profile and the population segment of the patient with the extracted one or more influence factors and the one or more population profiles in the generated one or more knowledge bases, respectively. The system further includes an advisory information generation processor in the computing server configured to generate based on the comparison, a personalized advisory information comprising a set of choices for the one or more clinical care pathway elements automatically for the patient. Further, the determined set of choices in the personalized advisory information are rendered on an interactive user interface of the user-computing device over the communication network for selection by a medical practitioner.

According to embodiments illustrated herein, there may be provided a computer program product for use with a computing device. The computer program product comprises a non-transitory computer readable medium storing a computer program code for medical data processing for generating personalized advisory information by computing server. The computer program code is executable by one or more transceivers in a computing server to receive a request comprising a generic clinical care pathway report and medical data of a patient from a user-computing device over a communication network. Further, the medical data comprises one or more factors associated with a patient profile and a population segment of the patient. The computer program code is further executable by the one or more processors in the computing server to extract one or more influence factors and one or more population segments from one or more data sources based on a plurality of unsupervised data mining techniques to generate one or more knowledge bases. Further, the one or more influence factors and one or more population segments may correspond to one or more clinical care pathway elements in the generic clinical care pathway report in the received request. The computer program code is further executable by the one or more processors in the computing server to compare the one or more factors associated with the patient profile and the population segment of the patient with the extracted one or more influence factors and the one or more population profiles in the generated one or more knowledge bases, respectively. The computer program code is further executable by the one or more processors in the computing server to generate based on the comparison, a personalized advisory information comprising a set of choices for the one or more clinical care pathway elements automatically for the patient. Further, the determined set of choices in the personalized advisory information are rendered on an interactive user interface of the user-computing device over the communication network for selection by a medical practitioner.

### BRIEF DESCRIPTION OF DRAWINGS

The accompanying drawings illustrate the various embodiments of systems, methods, and other aspects of the disclosure. A person having ordinary skills in the art would appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments can be implemented, in accordance with at least one embodiment;

FIG. 2 is a block diagram that illustrates a system for medical data processing for generating personalized advisory information by a computing server, in accordance with at least one embodiment;

FIGS. 3A, 3B, and 3C are flowcharts that illustrate a method for medical data processing for generating personalized advisory information by a computing server, in accordance with at least one embodiment;

FIG. 4 is a block diagram that illustrates an exemplary scenario for generating personalized advisory information by syntactic influence factor extraction method, in accordance with at least one embodiment; and

FIG. 5 is a block diagram that illustrates an exemplary scenario for generating personalized advisory information by semantic influence factor extraction method, in accordance with at least one embodiment.

### DETAILED DESCRIPTION

The present disclosure may be best understood with reference to the detailed figures and description set forth herein. Various embodiments are discussed below with reference to the figures. However, those skilled in the art would readily appreciate that the detailed descriptions given herein with respect to the figures are simply for explanatory purposes, as the method and system may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

### Definitions

The following terms shall have, for the purposes of this application, the respective meanings set forth below:

A “user-computing device” refers to a computer, a device (that includes one or more processors/microcontrollers and/or any other electronic components), or a system (that performs one or more operations according to one or more sets of programming instructions, codes, or algorithms) associated with a patient. In an embodiment, the patient may utilize the user-computing device to transmit a request for medical data processing for generating personalized advisory information to an application server over a communication network. Further, the request may comprise a generic clinical care pathway report and medical data of the patient. Examples of the user-computing device may include, but are not limited to, a desktop computer, a laptop, a personal digital assistant (PDA), a mobile device, a smartphone, and a tablet computer (e.g., iPad® and Samsung Galaxy Tab®).

A “medical data” refers to a documentation of health condition of a patient. The medical data may comprise one or more factors associated with a patient profile and a population segment of the patient. In an embodiment, the medical data may include one or more pre-existing diseases, current diseases, remarks, current drug prescriptions for the current diseases, and a population segment of the patient, which may have been documented periodically. Further, the medical data may include notes documented over time by a healthcare professional, such as a doctor, a nurse, or a medical attender. In an embodiment, the notes may include recorded observations, administered drugs and therapies, test results, X-rays, nursing reports, investigative reports, etc. In an embodiment, the medical data may be documented on a computing device, such as, but not limited to, a desktop computer, a laptop, a PDA, a mobile device, a smartphone, a tablet computer, and the like. In an embodiment, the medical data may be an electronic or handwritten document. In case of the handwritten document (such as on a paper), the medical data may be scanned to obtained the electronic form.

A “patient profile” refers to a set of information pertaining to a patient. For example, the patient profile may include information, such as, but is not limited to, one or more pre-existing diseases of the patient, a current disease of the patient, one or more remarks on the one or more pre-existing diseases of the patient, a current drug prescription for the current disease and a population segment of the patient.

A “population profile” refers to a set of information pertaining to a plurality of patients. In an embodiment, the population profile may correspond to a group for which the selected choice of one or more clinical care pathway elements is most suitable to. For example, a selected choice of a clinical care pathway element, such as “bare metal stent,” is most suitable for a group of patients, such as a group of patients with “low drug adherence potential,” as another clinical care pathway element “drug eluting stent” requires a substantial time, such as “16-18 months,” of treatment, such as “Dual-antiplatelet therapy.” The population profile may include information, such as, but not limited to, an age of each of plurality of patients, a gender of each of the plurality of patients, a disease profile for one or more population segments, and one or more clinical characteristics exhibited by the one or more population segments. In an embodiment, the population profile may be extracted by analyzing the parse tree of the sentence.

“One or more population segments” refers to a characterized segmentation of a plurality of patients in one or more population segments based on one or more parameters associated with the patient. The one or more parameters in the characterized segmentation may include parameter, such as, but is not limited to, an age, a disease type, an income group.

“One or more factors” refers to one or more factors stored in a database that may be associated with the patient profile and the population segment. For example, the one or more factors associated with the patient profile may include pre-existing diseases of the patient, current diseases of the patient, remarks on the pre-existing diseases of the patient, current drug prescriptions for the current diseases, and a population segment of the patient. The one or more factors associated with the population segment may include one or more factors, such as, but is not limited to, age, gender, disease profile, and one or more clinical characteristics exhibited by the population segment.

A “clinical care pathway” refers to a collection of systematic set of concrete steps associated with the care management protocol for a specific surgical procedure or a disease treatment. Such steps may be referred to as elements of the clinical care pathway. The clinical care pathway may be categorized as a generic clinical care pathway or a personalized clinical care pathway, based on generic steps or personalized steps, respectively, associated with the care management protocol for the specific surgical procedure or the disease treatment of a patient. In a first scenario, wherein a generalized clinical care pathway is implemented for a surgical procedure, such as “cardiac catheterization,” generic care pathway elements may include steps such as “generic incision entry point,” “generic contrast,” “generic stent type,” “generic post-acute care,” and “generic discharge condition.” In a second scenario, wherein a personalized clinical care pathway is implemented for the surgical procedure, such as “cardiac catheterization,” personalized care pathway elements may include choices in steps such as “radial vs. femoral incision entry point,” “standard vs. special contrast,” “bare metal vs. drug eluting stent type,” “SNF vs. home care vs. extended LOS post-acute care,” and “BNP (peptide) value and ejection fraction discharge condition.” Such choices at every step may be based on the presence of a set of influence factors in patient and population segment of the patient. For example, “radial vs. femoral incision entry point” may be based on “bleeding score” of the patient, “standard vs. special contrast” may be based on “kidney disease score” of the patient, “bare metal vs. drug eluting stent type” may be based on “drug adherence potential” and “restenosis risk cost” of the patient, “SNF vs. home care vs. extended LOS post-acute care” may be based on “self-care capability” of the patient, and “BNP (peptide) value and ejection fraction discharge condition” may be based on “age and metabolic factors” of the patient.

A “generic clinical care pathway report” refers to a documentation of a collection of a systematic set of elements associated with a care management protocol for a specific surgical procedure or a disease treatment. In an embodiment, the generic clinical care pathway report may be designed using a “one cap fits all patients” approach. For example, in the generic clinical care pathway report, the medical practitioner, based on a generic evidence, may recommend to all the patients that ‘femoral entry’ is indicated as a best choice for an entry point, without considering a high potential bleeding risk in a patient based on current one or more factors and a generic evidence. Similarly, a choice of post-acute care has a number of choices, such as a release to skilled nursing facility (SNF), a home self-care, or an increased length of stay in hospital. But, the generic clinical care pathway report based on the “one cap fits all” approach may recommend same post-acute care to all the patients, without analyzing the current one or more factors of the patient.

“One or more influence factors” refers to a property of a patient that may be affected by a choice of one or more clinical care pathway elements. For example, in a clinical care pathway report for a cardiac catheterization, influence factors, such as “drug adherence potential” and “restenosis risk cost,” are two patient factors that may be influenced by the choice of one or more clinical care pathway elements, such as “a bare metal stent” and “a drug eluting stent,” for a generic stent type element.

A “polarity of influence factor” refers to an effect of the one or more influence factors based on the type of influence on one or more choices that may correspond to the clinical care pathway element. Further, the polarity of the influence factor may be a positive polarity or a negative polarity. For example, if the length of stay of a patient in a hospital increases by a choice of a clinical care pathway element, then the polarity of influence factor “hospital stay” is negative.

A “negative choice” refers to a choice when the choice positively affects an influence factor, such as “increases restenosis rate,” with a negative polarity or negatively affects an influence factor, such as “decreases patient comfort,” with a positive polarity. For example, if the length of stay of a patient in a hospital increases by a choice of a clinical care pathway element, then the polarity of influence factor “hospital stay” is negative and thus the choice of the clinical care pathway element will correspond to the negative choice.

A “positive choice” refers to a choice in personalized advisory information when the choice negatively affects an influence factor, such as “reduces renal dysfunction,” with a negative polarity or positively affects an influence factor, such as “increases patient comfort,” with a positive polarity. For example, if the length of stay of a patient in a hospital decreases by a choice of a clinical care pathway element, then the polarity of influence factor “hospital stay” is positive and thus the choice of the clinical care pathway element will correspond to the positive choice.

A “direction of an influence factor” may refer to an impact of a choice of a clinical care pathway element on the influence factor. For instance, for a sentence “drug eluting stent reduces restenosis risk and cost,” the choice of the clinical care pathway element “drug eluting stent” “decreases” the influence factor “restenosis risk and cost.”

A “direction of Influence on population profile” may be defined by the direction of the impact of a choice of the clinical care pathway element on the type of population segment a patient belongs to. For example, for a sentence, “Coronary Artery Bypass Grafting is associated with a greater survival benefit than Percutaneous Transluminal Coronary Angioplasty among patients with severe renal dysfunction.” From the sentence, the following tuple may be constructed: <Coronary Artery Bypass Grafting, greater, survival benefit, patients with severe renal dysfunction, Percutaneous Transluminal Coronary Angioplasty> where, the choice of the clinical care pathway element are “Coronary Artery Bypass Grafting,” “Percutaneous Transluminal Coronary Angioplasty,” the influence factor is “survival benefit,” the direction of the influence factor is “increasing” [based on greater], the population profile is “patients with severe renal dysfunction,” and the direction of influence on population profile is “increasing.”

“One or more knowledge bases” refer to medical databases wherein knowledge, which is extracted from clinical outcomes research literature corpus via unsupervised approaches, is stored for generating personalized clinical care pathways for specific patient or population segment. The extracted knowledge may correspond to influence factors and population group from the clinical outcomes research literature corpus for selection of clinical care pathway elements. Using the extracted influence factors from the one or more knowledge bases, an interactive advisory tool rendered at the user interface of the user-computing device helps the medical practitioner make an appropriate choice for the clinical care pathway element in an automated manner, taking into account patient profile and population specific factors of a current patient.

“One or more compound statements” refers to a plurality of child statements joined via specific keywords, such as conjunctions. The one or more compound statements may be split back into child statements that may be considered as individual statements for various stages, such as noun phrase identification, pruning, direction extraction, tuple extraction, and/or the like.

A “parse tree” refers to an ordered rooted tree in a formal and structured style. In an embodiment, parse tree may be constructed for each of the one or more compound statements tagged with the patient or population groups (POPG) using a metathesarus, such as unified medical language system (UMLS) tag. The parse tree may be analyzed to identify the maximal connected component anchored at a POPG tag that may contain characteristics of the patient.

A “noun phrase” refers to a phrase in a compound statement which may be identified when a breadth-first search of a parse tree is performed. The noun phrase may correspond to at least an influence factor and a choice for a clinical care pathway element. For example, in a pre-processed compound sentence, such as “Trans Radial approach has been shown to be superior to the femoral approach in terms of reducing vascular access complications and improving patient comfort,” an identified noun phrase is “femoral approach in terms of reducing vascular access complications and improving patient comfort.” Such noun phrase comprises a clinical care pathway element choice, such as “femoral approach,” influence factors, such as “vascular access complications” and “patient comfort,” and directions, such as “reducing” and “improving.” In an embodiment, the noun phrase may be further pruned when the noun phrase comprises more than one child noun phrase, two rules may be applied to the child noun phrases. According to a first rule, if the identified noun phrase further contains a noun phrase (NP) followed by a preposition phrase (PP), then sub-noun phrases contained in the PP may be identified. As a result, a noun phrase is identified from the NP of the original noun phrase and one or more sub-noun phrases are identified from the PP of the original noun phrase. For example, the noun phrases in the original noun phrase ““femoral approach in terms of reducing vascular access complications and improving patient comfort” are “femoral approach,” “vascular access complications,” and “patient comfort.” According to a second rule, similar to the PP in the first rule, subordinate clauses (SBAR) that may be contained in the original noun phrase are also identified. For example, in the sentence, “Drug-Eluting Stents requires anti-platelet therapy of 6-12 months compared to Bare metal stent which requires only 4 weeks of anti-platelet therapy,” the noun phrase identified as “Bare metal stent which requires only 4 weeks of antiplatelet therapy” may be further pruned to extract element choice “Bare metal stent” and influence factor “only 4 weeks of anti-platelet therapy.”

A “structured tuple” refers to a data structure that may consist of user-defined ordered list of elements identified from unstructured textual information. The ordered list of elements may comprise the clinical care pathway elements, such as a first choice corresponding to the clinical care pathway element, a direction of an influence factor from the first choice to a second choice corresponding to the clinical care pathway element, the influence factor of the first choice with respect to the second choice, and the second choice corresponding to the clinical care pathway element.

“Unified medical terms” refers to most relevant medical terms associated with one or more clinical care pathway elements, stored in a unified medical language system (UMLS). For example, according to the UMLS dictionary, a “Drug-eluting stent” has a most relevant medical term as “Drug Eluting Stents” and is a type of “Medical Device.”

“Personalized advisory information” refers to information that comprises a set of choices for each of one or more clinical care pathway elements. The set of choices in the personalized advisory information are rendered on an interactive user interface of a user-computing device for selection and validation by a medical practitioner. In an embodiment, the selection of a choice from the set of choices may depend on a presence of a set of influence factors in a patient profile or population segment of a patient. For example, the medical practitioner may select a choice “radial entry” in case the patient has a high potential bleeding risk. Similarly, the medical practitioner may select another choice “bare stent” in case the patient has a poor medication adherence. Likewise, the medical practitioner may select another choice “SNF” or “increased length of stay (LOS) in hospital” in case the patient has a poor self-care potential. The medical practitioner may select a choice from the set of choices to improve clinical outcome and cost reduction for the patient.

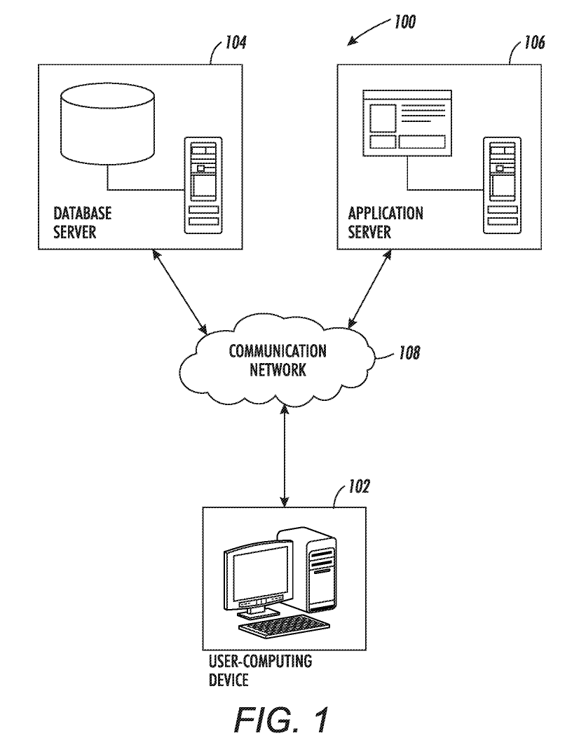

FIG. 1 is a block diagram of a system environment in which various embodiments of a method and a system for medical data processing for generating personalized advisory information by computing server may be implemented, in accordance with at least one embodiment. With reference to FIG. 1, a system environment 100 is shown that includes various devices, such as a user-computing device 102, a database server 104, and an application server 106. Various devices in the system environment 100 may be interconnected over a communication network 108. FIG. 1 shows, for simplicity, one user-computing device (such as the user-computing device 102), one database server, (such as the database server 104), and one application server (such as the application server 106). However, it will be apparent to a person with ordinary skill in the art that the disclosed embodiments may also be implemented using multiple user-computing devices, multiple database servers, and multiple application servers without departing from the scope of the disclosure.

The user-computing device 102 may refer to a computing device (associated with a patient) that may be communicatively coupled to other devices over the communication network 108. The user-computing device 102 may include one or more processors in communication with one or more memory units. Further, in an embodiment, the one or more processors may be operable to execute one or more sets of computer-readable code, instructions, programs, or algorithms, stored in the one or more memory units, to perform one or more operations.

The user-computing device 102 may be associated with a user, such as a patient or a medical practitioner. The user may utilize the user-computing device 102 to transmit a request to the application server 106 over the communication network 108. The request may correspond to the medical data processing for generating the personalized advisory information. The medical data of the patient may comprise medical records and one or more factors associated with a patient profile and a population segment of the patient.

In an embodiment, the user-computing device 102 may transmit/receive the medical records associated with the patient to/from one or more medical diagnosis devices corresponding to one or more medical departments, over the communication network 108. The medical records of the patient may include metadata such as, but not limited to, clinical notes (such as nursing notes, investigative reports, medication and allergies reports, laboratory test results, and/or the like) associated with the patient, measure of vital parameters, and other details (such as age and weight) of the patient.

In an embodiment, the user-computing device 102 may comprise a display screen that may be configured to display one or more user interfaces to the user. The user-computing device 102 may correspond to various types of computing devices, such as, but not limited to, a desktop computer, a laptop, a PDA, a mobile device, a smartphone, a tablet computer (e.g., iPad® and Samsung Galaxy Tab®), and the like.

The database server 104 may refer to a computing device or a storage device that may be communicatively coupled to other devices over the communication network 108. In an embodiment, the database server 104 stores one or more sets of instructions, code, scripts, or programs that may be executed to perform the one or more operations.

In an embodiment, the database server 104 may store one or more knowledge bases generated based on data extraction from one or more data sources. In an embodiment, the database server 104 may be configured to transmit or receive one or more instructions/metadata to/from one or more devices, such as the user-computing device 102 and the application server 106, over the communication network 108. For querying the database server 104, one or more querying languages may be utilized such as, but not limited to, structured query language (SQL), relational database query language (QUEL), data mining extensions (DMX), and so forth. In an embodiment, the database server 104 may be realized through various technologies, such as, but not limited to, Microsoft® SQL Server, Oracle®, IBM DB2®, Microsoft Access®, PostgreSQL®, MySQL®, and SQLite®.

The application server 106 refers to a computing device or a software framework hosting an application or a software service that may be communicatively coupled to other devices, such as the user-computing device 102 and the database server 104, over the communication network 108. In an embodiment, the application server 106 may be implemented to execute procedures, such as, but not limited to programs, routines, or scripts stored in one or more memory units for supporting the hosted application or the software service. In an embodiment, the hosted application or the software service may be configured to perform the one or more operations. In an embodiment, the one or more operations may include the processing of the medical data for generating the personalized advisory information.

In an embodiment, the application server 106 may be configured to receive the request from the user-computing device 102 for processing the medical data of the patient. Further, the application server 106 may be configured to extract the one or more influence factors and the one or more population profiles from the one or more data sources. The extraction of the one or more influence factors and the one or more population profiles from the one or more data sources may be based on a plurality of unsupervised data mining techniques to generate one or more knowledge bases.

Thereafter, the application server 106 may be configured to determine the presence of the external medical ontology in the received request. The external medical ontology may comprise the one or more medical terms, a category for each of the one or more medical terms, a detailed meaning of each of the one or more medical terms, and relations between two or more medical terms in the external medical ontology. Further, the application server 106 may be configured to extract the one or more influence factors from the one or more data sources by a syntactic method or a semantic method.

In an embodiment, the application server 106 may be configured to determine the polarity of the one or more influence factors. Thereafter, the application server 106 may be configured to identify and extract the one or more population profiles. Further, the application server 106 may be configured to compare the extracted one or more influence factors and the one or more population profiles with the one or more factors associated with the patient profile and the population segment.

Based on the comparison, the application server 106 may be configured to determine “positives” and “negatives” of a clinical care pathway element choice for that patient that may be rendered at the user-interface displayed at the display screen of the user-computing device 102. Further, a medical practitioner may validate the set of choices for the patient and transmit the validated set of choices to the application server 106. Accordingly, the application server 106 may generate a personalized advisory information for the patient and render the personalized advisory information at the user-interface displayed at the display screen of the user-computing device 102. In another embodiment, the application server 106 may be configured to store the generated personalized advisory information in the database server 104.

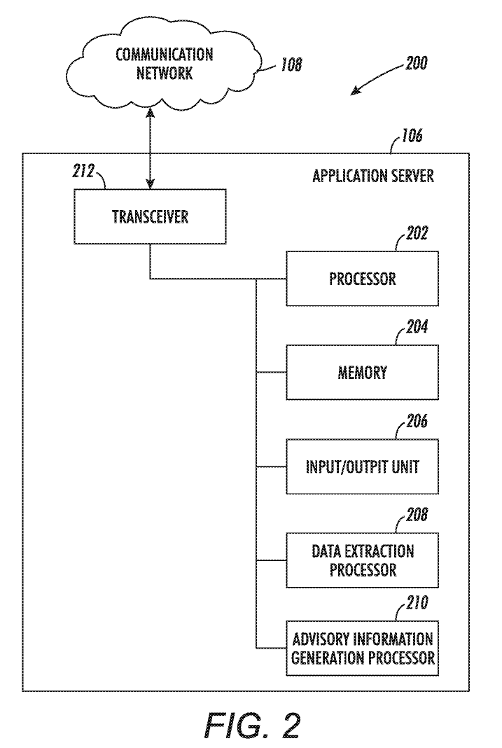

The application server 106 may be realized through various types of application servers, such as, but not limited to, a Java application server, a .NET framework application server, a Base4 application server, a PHP framework application server, or any other application server framework. An embodiment of the structure of the application server 106 is described later in FIG. 2.

A person with ordinary skill in the art would appreciate that the scope of the disclosure is not limited to realizing the database server 104 and application server 106 as separate entities. In an embodiment, the database server 104 may be realized as an application program installed on and/or running on the application server 106, without departing from the scope of the disclosure. Similarly, in an embodiment, the user-computing device 102 may be realized as an application program installed on and/or running on the application server 106, without departing from the scope of the disclosure.

The communication network 108 may include a medium through which one or more devices, such as the user-computing device 102, the database server 104, and the application server 106, may communicate with each other. Examples of the communication network 108 may include, but are not limited to, the Internet, a cloud network, a Wireless Fidelity (Wi-fi) network, a wireless local area network (WLAN), a local area network (LAN), a wireless personal area network (WPAN), a wireless wide area network (WWAN), a cloud network, a long-term evolution (LTE) network, a plain old telephone service (POTS), and/or a metropolitan area network (MAN). Various devices in the system environment 100 may be configured to connect to the communication network 108, in accordance with various wired and wireless communication protocols. Examples of such wired and wireless communication protocols may include, but are not limited to, transmission control protocol and internet protocol (TCP/IP), user datagram protocol (UDP), hypertext transfer protocol (HTTP), file transfer protocol (FTP), ZigBee, EDGE, infrared (IR), IEEE 802.11, 802.16, cellular communication protocols, such as long-term evolution (LTE), light fidelity (Li-Fi), and/or other cellular communication protocols or Bluetooth (BT) communication protocols.

FIG. 2 is a block diagram that illustrates a system for medical data processing for generating the personalized advisory information by the computing server, in accordance with at least one embodiment. With reference to FIG. 2, a system 200 is shown that may include a processor 202, a memory 204, an Input/Output (I/O) unit 206, a data extraction processor 208, an advisory information generation processor 210, and a transceiver 212.

The system 200 may correspond to a computing device, such as the user-computing device 102 or the application server 106, without departing from the scope of the disclosure. However, for the purpose of the ongoing description, the system 200 corresponds to the application server 106.

The processor 202 comprises a suitable logic, circuitry, interfaces, and/or a code that may be configured to execute the one or more sets of instructions, programs, or algorithms stored in the memory 204 to perform the one or more operations. For example, the processor 202 may be configured to receive a request from the user-computing device 102 over the communication network 108 to generate the personalized advisory information of a patient. In an embodiment, the processor 202 may be configured to receive the request from the user-computing device 102 for processing the medical data. Further, in an embodiment, when the processor 202 determines the presence of an external medical ontology, the processor 202 may identify the influence factors from unified medical terms using the external medical ontology. In an alternative embodiment, when the processor 202 determines the absence of an external medical ontology, the processor may identify the influence factors from a structured tuple. Further, the processor 202 may determine the polarity of each of the one or more influence factors. In an embodiment, the processor 202 may be communicatively coupled to the memory 204, the I/O unit 206, the data extraction processor 208, the advisory information generation processor 210, and the transceiver 212. The processor 202 may be further communicatively coupled to the communication network 108. The processor 202 may be implemented based on a number of processor technologies known in the art. The processor 202 may work in coordination with the processor 202, the memory 204, the I/O unit 206, the data extraction processor 208, the advisory information generation processor 210, and the transceiver 212 for generating the personalized advisory information. Examples of the processor 202 include, but are not limited to, an X86-based processor, a reduced instruction set computing (RISC) processor, an application-specific integrated circuit (ASIC) processor, a complex instruction set computing (CISC) processor, and/or other processors.

The memory 204 may be operable to store one or more machine code and/or computer programs that have at least one code section executable by the processor 202, the I/O unit 206, the data extraction processor 208, the advisory information generation processor 210, and the transceiver 212. The memory 204 may store the one or more sets of instructions, programs, code, or algorithms that are executed by the processor 202, the I/O unit 206, the data extraction processor 208, the advisory information generation processor 210, and the transceiver 212. In an embodiment, the memory 204 may include one or more buffers (not shown). In an embodiment, the one or more buffers may be configured to store the one or more compound statements, the medical data of the patient, the population profile of the patient. Some of the commonly known memory implementations may include, but are not limited to, a random access memory (RAM), a read only memory (ROM), a hard disk drive (HDD), and a secure digital (SD) card. It will be apparent to a person with ordinary skill in the art that the one or more instructions stored in the memory 204 enables the hardware of the system 200 to perform the one or more operations.

The I/O unit 206 comprises suitable logic, circuitry, interfaces, and/or a code that may be operable to facilitate the user to input one or more input parameters. For example, the requestor may utilize the I/O unit 206 to input the request pertaining to the generation of the personalized advisory information. In an embodiment, the medical practitioner may utilize the I/O unit to validate the set of choices in the received personalized clinical care pathway of the patient. The I/O unit 206 may be operable to communicate with the processor 202, the memory 204, the data extraction processor 208, the advisory information generation processor 210, and the transceiver 212. In an embodiment, the I/O unit 206, in conjunction with the processor 202 and the transceiver 212, may be operable to provide the one or more queried responses to the user. In an embodiment, the one or more queried responses may be rendered on the GUI in various forms, such as either in, a video form, a graphical form, or a text form. Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and a display screen.

The data extraction processor 208 comprises a suitable logic, circuitry, interfaces, and/or a code that may be configured to execute the one or more sets of instructions, programs, or algorithms stored in the memory 204 to perform the one or more operations. The one or more operations may include extracting the one or more influence factors and the one or more population profiles from the one or more data sources. The one or more operations may include extracting the plurality of phrases, the one or more medical keywords, the semantic types for each of the one or more compound statements in the one or more data sources. The data extraction processor 208 may be implemented based on a number of processor technologies known in the art. Examples of the data extraction processor 208 include, but are not limited to, an X86-based processor, a reduced instruction set computing (RISC) processor, an application-specific integrated circuit (ASIC) processor, a complex instruction set computing (CISC) processor, and/or other processors.

The advisory information generation processor 210 comprises a suitable logic, circuitry, interfaces, and/or a code that may be configured to execute the one or more sets of instructions, programs, or algorithms stored in the memory 204 to perform the one or more operations. Examples of the one or more operations may include automatically generating the personalized advisory information of the patient. The advisory information generation processor 210 may be implemented based on a number of processor technologies known in the art. Examples of the advisory information generation processor 210 include, but are not limited to, an X86-based processor, a reduced instruction set computing (RISC) processor, an application-specific integrated circuit (ASIC) processor, a complex instruction set computing (CISC) processor, and/or other processors.

The transceiver 212 comprises a suitable logic, circuitry, interfaces, and/or a code that may be configured to receive/transmit the one or more queries, request, medical data, or other information from/to one or more computing devices or servers (e.g., the user-computing device 102, the database server 104, or the application server 106) over the communication network 108. The transceiver 212 may implement one or more known technologies to support wired or wireless communication with the communication network 108. In an embodiment, the transceiver 212 may be configured to retrieve the multimedia content from the database server 104. In an embodiment, the transceiver 212 may include circuitry, such as, but not limited to, an antenna, a radio frequency (RF) transceiver, one or more amplifiers, a tuner, one or more oscillators, a digital signal processor, a universal serial bus (USB) device, a coder-decoder (CODEC) chipset, a subscriber identity module (SIM) card, and/or a local buffer. The transceiver 212 may communicate via wireless communication with networks (such as the Internet), an Intranet and/or a wireless network (such as a cellular telephone network), a WLAN, and/or a metropolitan area network (MAN). The wireless communication may use any of a plurality of communication standards, protocols, and technologies, such as global system for mobile communications (GSM), enhanced data GSM environment (EDGE), wideband code division multiple access (W-CDMA), code division multiple access (CDMA), time division multiple access (TDMA), Bluetooth, light fidelity (Li-Fi), Wi-Fi (e.g., IEEE 802.11a, IEEE 802.11b, IEEE 802.11g, and/or IEEE 802.11n), voice over Internet Protocol (VoIP), Wi-MAX, a protocol for email, instant messaging, and/or short message service (SMS).

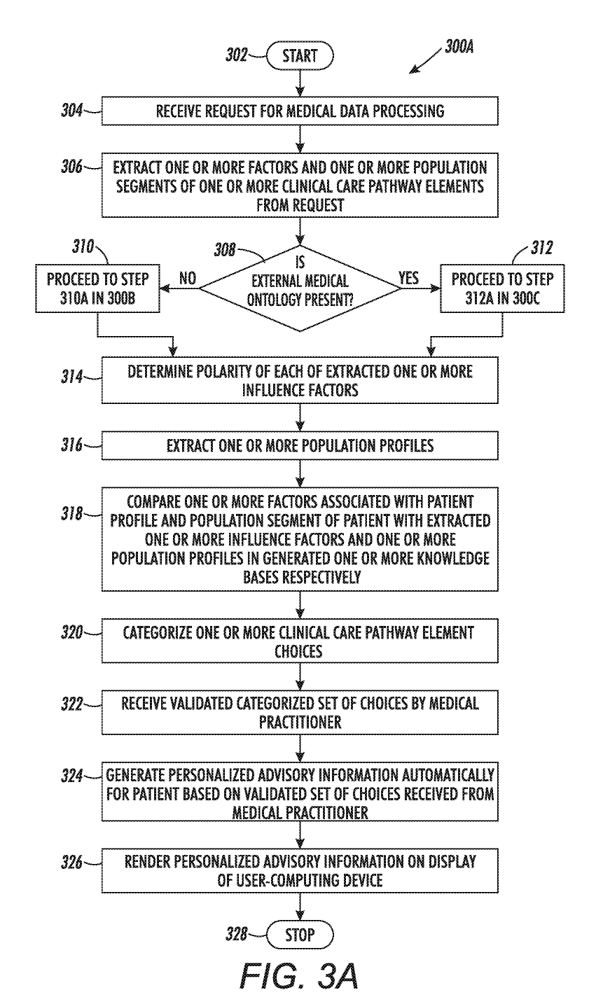

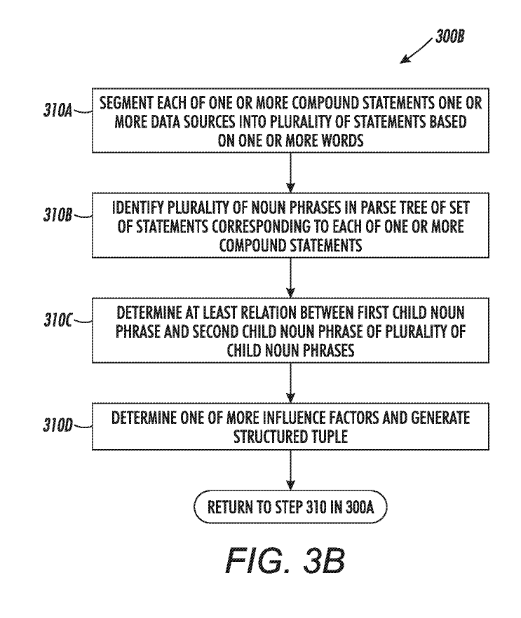

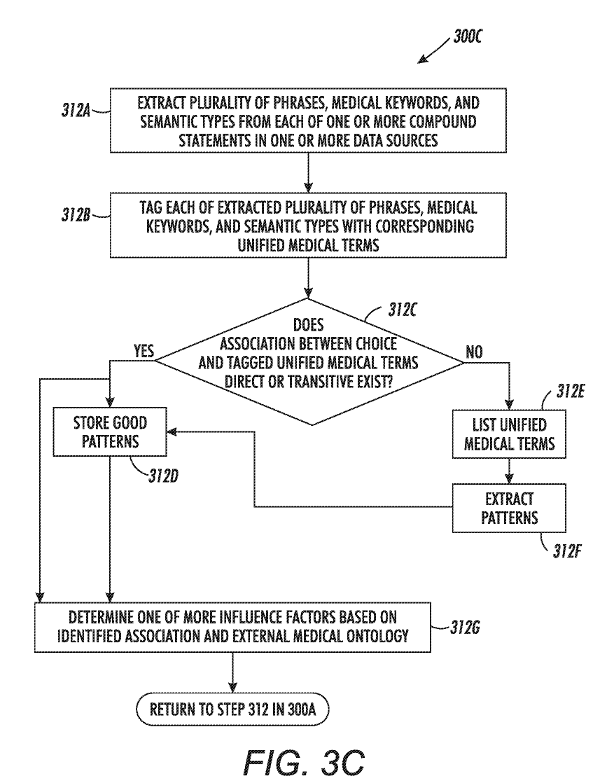

FIGS. 3A, 3B, and 3C are flowcharts that illustrate a method for medical data processing for generating personalized advisory information by a computing server, in accordance with at least one embodiment. With reference to FIG. 3A, a flowchart 300A is shown that is described in conjunction with FIG. 1 and FIG. 2. The method starts at step 302 and proceeds to step 304.

At step 304, a request is received from a user-computing device 102 for processing medical data of a patient. In an embodiment, the processor 202 may be configured to receive the request from the user-computing device 102 through the transceiver 212, over the communication network 108, for processing the medical data of the patient.

In an embodiment, the request may include a generic clinical care pathway report 402 and medical data of a patient, for whom a personalized surgical procedure or disease treatment is to be performed. Further, the generic clinical care pathway report 402 may include, one or more generic clinical care pathway elements, i.e. generic steps, for performing the surgical procedure or the disease treatment of the patient. The medical data may include a patient profile and a population segment, and one or more factors associated with the patient profile and the population segment of the patient. The patient profile may include one or more of pre-existing diseases, current diseases, remarks, current drug prescription for the current diseases, and a population segment that the patient belongs to, such as young, elderly, or diabetic. The population segment of the patient may comprise age, gender, disease profile for the population segment, and the one or more clinical characteristics exhibited by the population segment that may be relevant to a selection of clinical care pathway element.

In an embodiment, the medical data of the patient may correspond to one or more handwritten medical records (or handwritten notes) documented by one or more healthcare professionals, such as, but not limited to, a doctor, a nurse, a medical attendant, or a hospital staff. In such a case, in an embodiment, the one or more handwritten medical records may be scanned by utilizing a multi-function device (MFD). Such scanned one or more handwritten medical records may be converted to one or more electronic records by the MFD and stored in the database server 104. Alternatively, the converted one or more electronic records may be directly communicated to the application server 106 by the MFD, over the communication network 108.

A person with ordinary skill in the art would understand that the instances of the medical data is for illustrative purpose and should not be construed to limit the scope of the disclosure.

At step 306, one or more influence factors and one or more population profiles corresponding to one or more clinical care pathway elements in the generic clinical care pathway report 402 in the received request are extracted. In an embodiment, the data extraction processor 208 may be configured to extract the one or more influence factors and the one or more population profiles from the one or more data sources. The extraction of the one or more influence factors and the one or more population profiles from the one or more data sources may be based on a plurality of unsupervised data mining techniques to generate one or more knowledge bases.

The one or more influence factors may refer to a property of a patient that may be affected by a choice of one or more clinical care pathway elements. For example, in a clinical care pathway report for a cardiac catheterization, influence factors, such as “drug adherence potential” and “restenosis risk cost,” are two patient factors that may be influenced by the choice of one or more clinical care pathway elements, such as “a bare metal stent” and “a drug eluting stent,” for a generic stent type element. The one or more population profiles may refer to population groups for which the selected choice of one or more clinical care pathway elements is most suitable to. For example, a choice of one or more clinical care pathway elements, such as “bare metal stent,” is most suitable for patients with “low drug adherence potential’ as “drug eluting stent” requires “16-18 months” of “Dual-antiplatelet therapy.”

A person with ordinary skill in the art would understand that the examples of the influence factors and population profiles are for illustrative purpose and should not be construed to limit the scope of the disclosure.

At step 308, a check is performed to determine whether the received request comprises an external medical ontology. In an embodiment, the processor 202 may be configured to perform the check to determine whether the received request comprises the external medical ontology. In an embodiment, the external medical ontology may comprise the one or more unified medical terms, a category for each of the one or more medical terms, a detailed meaning of each of the one or more medical terms, and relations between two or more medical terms. In an embodiment, the processor 202 may be configured to identify influence factors from the unified medical terms using the external medical ontology. In an embodiment, the processor 202 may be configured to automatically generate the external medical ontology using one or more information extraction and one or more text mining methods. The external ontology may further comprise one or more ontology libraries. In an instance, when the processor 202 determines that the received request does not comprise the external medical ontology, the control passes to step 310. Else, the control passes to step 312.

At step 310, when it is determined that the received request does not comprise the external medical ontology, the processor 202 may utilize a syntactic method for extraction of influence factor from the one or more data sources. The syntactic method exploits at least the meaning of words, sentences, and structures in which the words appear together and finds influence factors by leveraging the syntactic structures of sentences and part-of-speech (PoS) tags. The control passes to step 310A in flow chart 300B in FIG. 3B.

At step 310A, each of one or more compound statements in one or more data sources are segmented into a plurality of statements. In an embodiment, the processor 202 may be configured to segment each of the one or more compound statements in the one or more data sources into the plurality of statements, based on one or more segmentation techniques known in the art. In an embodiment, the processor 202 may segment one or more compound statements that contain two child sentences joined by a conjunction. Each child sentence is then treated as an individual sentence in the following stages. The processor 202 may further remove one or more segments that correspond to non-ASCII characters and special characters.

At step 310B, a plurality of noun phrases are identified in parse tree of set of statements corresponding to each of one or more compound statements. In an embodiment, the processor 202 may be configured to identify when a breadth-first search of a parse tree of set of statements corresponding to each of one or more compound statements is performed. The noun phrase may correspond to at least an influence factor and a choice for a clinical care pathway element. For example, in a pre-processed compound sentence, such as “Trans Radial approach has been shown to be superior to the femoral approach in terms of reducing vascular access complications and improving patient comfort,” an identified noun phrase is “femoral approach in terms of reducing vascular access complications and improving patient comfort.” Such noun phrase comprises a clinical care pathway element choice, such as “femoral approach,” influence factors, such as “vascular access complications” and “patient comfort,” and directions of influence factors, such as “reducing” and “improving.”

In an embodiment, the noun phrase may be further pruned when the noun phrase comprises more than one child noun phrase. In such a case, a rule, such as NP-PP rule or NP-SBAR rule, may be applied to the children of noun phrases. According to the first rule, i.e., NP-PP rule, if the identified noun phrase further comprises a noun phrase (NP) followed by a preposition phrase (PP), then sub-noun phrases contained in the PP may be identified. As a result, a noun phrase is identified from the NP of the original noun phrase and one or more sub-noun phrases are identified from the PP of the original noun phrase. For example, the noun phrases in the original noun phrase “femoral approach in terms of reducing vascular access complications and improving patient comfort” are “femoral approach,” “vascular access complications,” and “patient comfort.” According to the second rule, i.e., NP-SBAR rule, similar to the PP in the first rule, subordinate clauses (SBAR) that may be contained in the original noun phrase are also identified. For example, in the sentence, “Drug-Eluting Stents requires anti-platelet therapy of 6-12 months compared to Bare metal stent which requires only 4 weeks of anti-platelet therapy,” the noun phrase identified as “Bare metal stent which requires only 4 weeks of antiplatelet therapy” may be further pruned to extract element choice “Bare metal stent” and influence factor “only 4 weeks of anti-platelet therapy.”

At step 310C, a relation between a first child noun phrase and a second child noun phrase of the child noun phrases is determined. In an embodiment, the processor 202 may be configured to determine a direction, which may termed as the relation between the first child noun phrase, such as a clinical care pathway element, and the second child noun phrase, such as an influence factor, of the child noun phrases. The processor 202 may be configured to determine the direction based on the dependency parse tree of the sentence from which the noun phrases are identified. Examples of the relations that may occur across different noun phrases may include, but are not limited to, adjectival modifier (amod), nominal modifier (nmod), nominal subject (nsubj), passive nominal subject (nsubjpass), direct object (dobj), and negation (neg) relation. From the above dependency relations, the processor 202 may identify various relations that may be potentially the direction of relation between a clinical care pathway element (i.e., the first child noun phrase) and an influence factor (i.e., the second child noun phrase).

At step 310D, a structured tuple is generated. In an embodiment, the processor 202 may be configured to generate the structured tuple, such as <first choice for clinical care pathway element, direction of influence factor, influence factor, second choice for clinical care pathway element>. Since the population phrase has been extracted out, it may be a fair assumption that each identified noun phrase corresponds to either a clinical care pathway element choice or an influence factor. Since the list of clinical care pathway element choices is known, the processor 202 may identify all other noun phrases as influence factors. The direction of influence factor may be taken as that relation between a clinical care pathway element choice and influence factor, out of all the relations found in previous stage. Based on the number of identified noun phrases, the processor 202 may determine that a single noun phrase may correspond to a clinical care pathway element choice, such as “Drug-Eluting Stents are the best choice” may yield a tuple <Drug-Eluting Stents; best>. The processor 202 may further determine that two or more noun phrases may contain one or more clinical care pathway element choices and one or more influence factors. For instance, a sentence “Drug-Eluting Stents are superior to Bare Metal Stents” may yield <Drug-Eluting Stents; superior; Bare Metal Stents> and another sentence “Bare metal stent has higher risk of restenosis as compared with Drug-Eluting Stents” may yield <Drug-Eluting Stents; higher; risk of restenosis; Bare Metal Stents>. It may be noted that in certain cases, the extraction of influence factors using syntactic method may not cater to understand meaning of the extracted noun phrases and whether there exists a logical relationship between the extracted noun phrases. In such a case, the processor 202 may identify the nature of the relationship using the semantic method for the extraction of influence factors. In such a case, control passes to step 312. Otherwise, control returns to step 314 in the flowchart 300A of FIG. 3A.

With reference to step 308 of the flowchart 300A of FIG. 3A, in an embodiment, when the processor 202 determines that the received request comprises the external medical ontology, the control passes to step 312.

At step 312, when it is determined that the received request comprises the external medical ontology, the processor 202 may utilize a semantic method for extraction of one or more influence factors from the one or more data sources. The semantic method aims at not only extracting clinical care pathway element choice and the corresponding influence factor, but also the type of semantic relationship between the clinical care pathway element choice and the corresponding influence factor, the type of both the clinical care pathway element choice and the influence factor and in what good structures do the clinical care pathway element choice and the influence factor appear together in a sentence, so that in future, relevant influence factor may be tagged using the identified good structures. Control passes to step 312A in flowchart 300C in FIG. 3C.

At step 312A, a plurality of phrases, medical keywords, and semantic types are extracted from each of one or more compound statements in one or more data sources. In an embodiment, the data extraction processor 208 may execute an automated tool, such as UMLS metathesarus tool, to extract a plurality of phrases, medical keywords, and the semantic types for each of the one or more compound statements in the one or more data sources. In an exemplary scenario, in a compound sentence, such as “bare metal stent has higher risk of restenosis as compared with drug-eluting stents,” the processor 202 may determine the most relevant medical term for “drug-eluting stent” as “drug eluting stents” and determine, according to the UMLS dictionary, the corresponding unified medical term as “Medical Device.”

At step 312B, each of the extracted plurality of phrases, medical keywords, and semantic types are tagged with corresponding unified medical terms. In an embodiment, the processor 202 may be configured to tag each of the extracted plurality of phrases, medical keywords, and semantic types with the corresponding unified medical terms. The processor 202 may further generate a dependency parse tree to indicate the structures in which the tagged unified medical terms appear with the clinical care pathway element choice in the one or more data sources, such as the research literature corpus.

At step 312C, a check is performed to determine whether a direct or a transitive association exists between a clinical care pathway element choice and the tagged unified medical terms. In an embodiment, the processor 202 may be configured to determine whether the direct or the transitive association exists between the clinical care pathway element choice and the tagged unified medical term, based on the external knowledge ontology.

In an embodiment, the processor 202 may determine a direct relation, indicated by a keyword, such as “associated with,” between the clinical care pathway element choice and the tagged unified medical term, based on the external knowledge ontology. In such a case, the processor 202 may determine the tagged unified medical term as an influence factor. In an exemplary scenario, for a sentence “Drug eluting stents reduces renal dysfunction,” the following terms are extracted:
Clinical care pathway element choice: Drug-eluting stent [Medical Device]
Unified Medical Term: renal dysfunction [Disease or Syndrome]
Direct relation in ontology: Medical Device|TREATS|Disease or Syndrome
Extracted clinical care pathway element Choice: Drug-eluting stent
Extracted Influence fact or: renal dysfunction

In the exemplary scenario, “TREATS” may indicate a relation between two terms “Medical Device” and “Disease or Syndrome.” Given a clinical care pathway element choice and a tagged unified medical term, the relation between the two terms, according to the external knowledge ontology, is semantically mapped to “associated with.” Other examples of semantically similar relations to represent an association between two terms may include, but are not limited to, “causes,” “diagnoses,” “associated with,” “coexists with,” “affects,” “interacts with,” “complicates,” “prevents,” “disrupts,” “produces,” “pre-disposes,” “inhibits,” “augments,” “stimulates,” and their respective negative versions. Thus, if a clinical care pathway element choice and a unified medical term are directly related to each other, the processor 202 may determine the unified medical term as an influence factor.

In another embodiment, the processor 202 may determine a transitive relation, indicated by a concatenated keyword, such as “causes-associated with,” between the clinical care pathway element choice and the tagged unified medical term, based on the external knowledge ontology. In such a case, the processor 202 may determine the tagged unified medical term as an influence factor. Such an embodiment may overcome the limitation of direct relations, wherein various potential influence factors may be missed. Thus, the processor 202 identifies transitive relations between two unified medical terms. For example, if <clinical care pathway element choice> CAUSES <Acquired Abnormality> and <Acquired Abnormality> ASSOCIATED WITH <Injury or Poisoning> are two relations that exist in the external knowledge ontology, however no relation describes association of <clinical care pathway element choice> and <Injury and Poisoning>, the processor 202 may identify the association a transitive association and name the relation as the concatenation of individual relations (<CAUSES-ASSOCIATED WITH). In an exemplary scenario, for a sentence “Prasugrel leads to a significant reduction in ischemic cardiovascular events among compared to clopidogrel,” the following terms are extracted:
Clinical care pathway element choice: Prasugrel [Pharmacologic Substance]
Unified Medical Terms: in ischemic cardiovascular events among [Finding]
Direct Relation in ontology: Pharmacologic Substance|CAUSES|Acquired Abnormality Acquired Abnormality|ASSOCIATED WITH|Finding
Transitive Relation: Pharmacologic Substance|CAUSES-ASSOCIATED WITH|Finding
Extracted clinical care pathway element Choice: Prasugrel
Extracted Influence factor: in ischemic cardiovascular events

In an embodiment, when the processor 202 determines that the direct or the transitive association exists between the clinical care pathway element choice and the tagged unified medical term, the control passes to step 312D in one instance. In another instance, the control directly passes to step 312G. In an alternative embodiment, when the processor 202 determines that there exists no direct or the transitive association between the clinical care pathway element choice and the tagged unified medical term, the control passes to step 312E.

At step 312D, when it is determined that the direct or the transitive association exists, the processor 202 may be configured to identify path-of-words that appear on a path traversing the clinical care pathway element choice to the unified medical term in the dependency parse tree. In such an embodiment, the processor 202 may be configured to register the identified path-of-words as good patterns in the database server 104. The control passes to step 312G.

At step 312E, when it is determined that the direct or the transitive association does not exist, the processor 202 may be configured to identify the influence factors that are missed due to one or more reasons, such as a non-unified medical term or a single-hop transitive relation. Such influence factors may be identified by the processor 202 by use of a pattern extraction technique to tag the non-unified medical terms as influence factors based on the similarity in the pattern of the non-unified medical term with the clinical care pathway element choice.

At step 312F, one or more patterns are extracted from the tagged unified medical terms as the influence factors based on the similarity in the pattern of the non-unified medical term with the clinical care pathway element choice. Control passes to step 312D wherein the one or more extracted patterns are stored as good patterns in the database server 104.

At 312G, one or more influence factors are determined based on the identified association and the external medical ontology. In an embodiment, the processor 202 may be configured to determine the one or more influence factors based on the identified association and the external medical ontology.

In an exemplary scenario, in a compound statement, such as “Drug-eluting stents (DES) are composed of a stainless steel back-bone encompassed by a polymer in which a variety of drugs that inhibit ‘smooth muscle cell proliferation’ and excessive neointima formation are incorporated.” Here, “smooth muscle cell proliferation” is of type “cell function” in the ontology. Further, the processor 202 may determine no direct or transitive relation in the compound statement that exists in the ontology that connects the “Medical Device” (DES) with “cell function.” However, according to the sentence, semantically, DES inhibits smooth muscle cell proliferation and hence the later may be an influence factor. Such influence factors are extracted by the pattern extractor. In an embodiment, the processor 202 may determine a similarity between a test pattern and a good pattern using Jaccard index of verbs, known in the art. In the exemplary scenario, for the compound statement “Drug-eluting stents (DES) are composed of a stainless steel back-bone encompassed by a polymer in which a variety of drugs that inhibit smooth muscle cell proliferation′ and excessive neointima formation are incorporated,” the following terms are extracted:
Choice: Drug-eluting stent [Medical device]
Unified Medical Terms: smooth muscle cell proliferation [Cell function]
Direct Relation in ontology: None
Transitive Relation: None
Test Pattern from the sentence: medd->composed->of->backbone->encompassed->by->polymer->inhibit->celf.
Matching good pattern:->inhibits->
Extracted clinical care pathway element Choice: Drug-eluting stent
Extracted influence factor: smooth muscle cell proliferation

A person with ordinary skill in the art would understand that the example of the pattern determination is for illustrative purpose and should not be construed to limit the scope of the disclosure. Control passes back to step 314 in flowchart 300A in FIG. 3A.

At step 314, polarity of one or more influence factors is determined. In an embodiment, the processor 202 may be configured to determine the polarity of the one or more influence factors, which are determined factors by the flowchart 300B or 300C. The polarity of the one or more influence factors indicate whether an influence factor positively or negatively influences choices corresponding to a clinical care pathway element. In other words, the processor 202 may automatically determine the polarity of each of the one or more influence factors based on the type of influence on one or more choices corresponding to the clinical care pathway element. For example, ideally, an influence factor “hospital stay” should be decreased by a clinical care pathway element choice. A longer hospital stay may imply ineffectiveness of the clinical care pathway element choice and hence, the clinical care pathway element choice should not be made. This shows that the influence factor “hospital stay” is associated with a negative connotation, which should be decreased and not increased. Thus, the polarity of the influence factor “hospital stay” is negative.

Further, the processor 202 may generate a lexicon of the determined polarity of each of the one or more influence factors annotated from ground truth data, which is generated based on manual annotation of sentences with corresponding information, such as influence factor, direction of influence factor, population of interest, and choices. The processor 202 may utilize the generated lexicon to estimate polarity of next influence factors. In an embodiment, the processor 202 may be configured to store one or more clinical care pathway elements, one or more clinical care pathway element choices, one or more influence factors, and the direction of the one or more influence factors in one of the one or more knowledge bases.

At step 316, one or more population profiles are identified and extracted. In an embodiment, the data extraction processor 208 may be configured to identify and extract the one or more population profiles to which the one or more influence factors are applicable to. In an embodiment, the processor 202 may utilize one or more unsupervised techniques to extract the one or more population profiles. The processor 202 may anchor the presence of the one or more population profiles, indicated by a patient or population group (POPG), in the one or more compound statements in the one or more data sources. The processor 202 may further utilize a syntactic technique by analyzing the parse tree of the sentence to extract the population profile. In an embodiment, the processor 202 may use an automated tool, such as UMLS metathesarus tool, to identify the POPG anchor terms, such as patients, people, elder, female, male, and the like, and tag the POPG group to the sentence. For each sentence tagged with POPG by use of a unified medical term tag, such as UMLS tag, the processor 202 may construct a parse tree. In the parse tree, the processor 202 identifies a maximal connected component anchored at the POPG tag. The syntactic analysis may utilize the fact that any characteristics associated with the POPG is required to be anchored at the POPG term and the maximal connected component in the parse tree involving the POPG tag contains the patient characteristics. Using such an unsupervised approach doesn't require annotated data and is highly scalable even for complex sentences with large parse tree, given that connected components in the parse tree are identified in linear time. In an embodiment, the data extraction processor 208 may be configured to store one or more population profiles and direction of Influence on the one or more population profiles in other one or more knowledge bases.

In an exemplary scenario, for a compound statement, such as “DES is contra-indicated in patients who cannot sustain 6-12 months of dual antiplatelet therapy,” the processor 202 may determine the population profile as “patients who cannot sustain 6-12 months of dual antiplatelet therapy.” In another exemplary scenario, for a compound statement, such as “Radial approach may cause more access site pain as compared with a femoral approach in patients with a low BMI and small wrist circumference,” the processor 202 may determine the population profile as “patients with a low BMI and small wrist circumference.” In another exemplary scenario, for a compound statement, such as “In patients who had previously undergone CABG surgery, TRA was associated with greater contrast use, longer procedure time, and greater access crossover and operator radiation exposure compared with TFA” the processor 202 may determine the population profile as “patients who had previously undergone CABG surgery.”

A person with ordinary skill in the art would understand that the above examples of the population profiles are for illustrative purpose and should not be construed to limit the scope of the disclosure.

At step 318, one or more factors associated with patient profile and population segment of the patient is compared with the extracted one or more influence factors and the one or more population profiles, respectively, in the generated one or more knowledge bases. In an embodiment, the processor 202 may be configured to compare the one or more factors for each of the one or more element choices, associated with the patient profile and the population segment of the patient with the extracted one or more influence factors and the one or more population profiles, respectively, in the generated one or more knowledge bases. The processor 202 may be configured to perform an efficient lookup in the knowledge bases for such comparison.

At step 320, post comparison of the one or more factors associated with the patient profile and the population segment of the patient with the extracted one or more influence factors and the one or more population profiles, the processor 202 may categorize the one or more clinical care pathway element choices, in other words a set of choices, based on determination of the “positive” or “negative” of each of the one or more clinical care pathway element choices for the patient. More specifically, based on the comparison of the one or more factors in the patient profile of the patient with the relevant influence factors of a clinical care pathway element choice, the advisory information generation processor 210 may determine “positives” and “negatives” of a clinical care pathway element choice for that patient. In other words, a clinical care pathway element choice in the personalized advisory information is a “positive” choice when the clinical care pathway element choice negatively affects an influence factor with a negative polarity or positively affects the influence factor with a positive polarity. Similarly, a clinical care pathway element choice in the personalized advisory information is a “negative” choice when the clinical care pathway element choice positively affects an influence factor with a negative polarity or negatively affects an influence factor with a positive polarity.

Further, the processor 202 may determine the effect of the clinical care pathway element choice on the population as “negative” or “positive.” Based on the comparison of the one or more factors in the population segment of the patient with the most suitable population profiles of a clinical care pathway element choice, the advisory information generation processor 210 may determine that negatively affected population is marked as a “negative” and positively affected population is marked as a “positive” for the clinical care pathway element choice. Accordingly, “positives” and “negatives” of a clinical care pathway element choice for that patient is determined based on the aforesaid two comparisons.

In an embodiment, the advisory information generation processor 210 may mark the clinical care pathway element choice as appropriate (or inappropriate) and list the influence factors under the categories “pros” (or “cons”) of the clinical care pathway element choice.

At step 322, a validated set of choices by the medical practitioner is received. In an embodiment, the processor 202 may be configured to receive the validated set of choices by the medical practitioner. Based on the receipt of the validated set of choices, the processor 202 may generate a personalized clinical care pathway for the patient. The processor 202 may be further configured to receive one or more comments or feedback provided by the medical practitioner via the user-computing device 102. The one or more comments or feedback may be provided by the medical practitioner based on past historical data and medical records of the patient.

At step 324, personalized advisory information is automatically generated for patient based on the validated set of choices received from the medical practitioner. The personalized advisory information, automatically generated by the advisory information generation processor 210, may be configured to may comprise the validated set of choices for one or more clinical care pathway elements.

At step 326, the personalized advisory information is rendered on the display of the user-computing device 102. The processor 202 may be configured to render the personalized advisory information on the display of the user-computing device 102. The processor 202 may further render the determined set of choices, i.e., the “pros” and “cons” of the clinical care pathway element choices, in the personalized advisory information at an interactive user interface of the user-computing device 102 over the communication network 108 for selection and/or validation by the medical practitioner. In an embodiment, the personalized advisory information may comprise one or more additional information pertaining to the medical profile of the patient. The process ends at step 328.

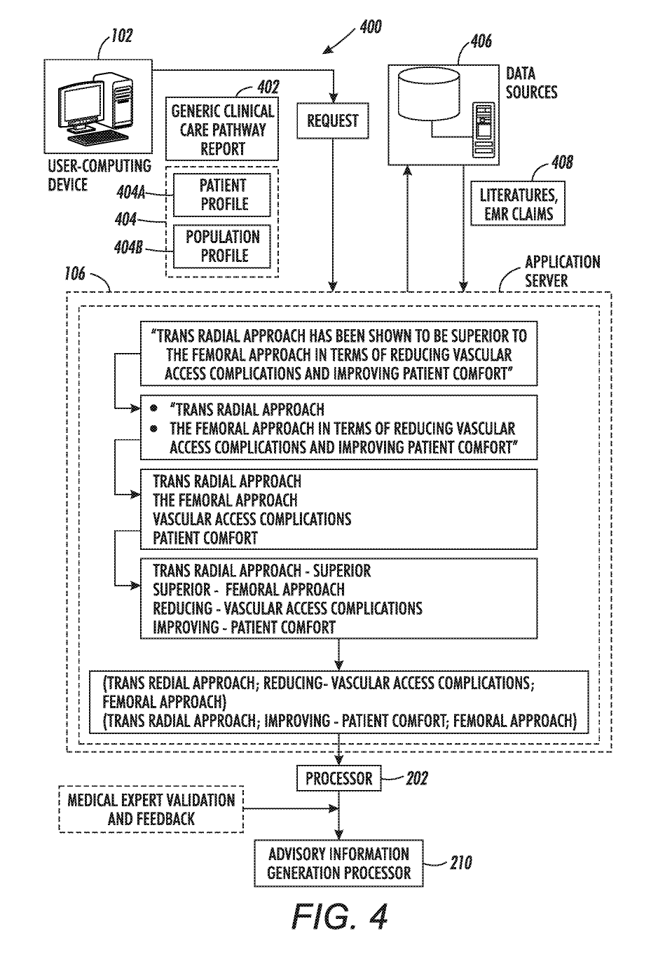

FIG. 4 is a block diagram that illustrates an exemplary scenario for generating personalized advisory information by syntactic influence factor extraction method, in accordance with at least one embodiment. FIG. 4 is described in conjunction with FIG. 1 to FIG. 3C. With reference to FIG. 4, there is shown an exemplary scenario 400 for generating personalized advisory information for a patient by syntactic influence factor extraction method.

With regard to the exemplary scenario 400, a user may request using a user-computing device 102 for processing the medical data of a patient. The request may include a generic clinical care pathway report 402 and medical data 404 of the patient. Further, the request may include a patient profile 404A, that may include the one or more pre-existing diseases, current disease, remarks, current drug prescription for the current disease and a population segment, such as young, elderly, or diabetic of the patient. Further, the population segment of the patient may comprise an age, a gender, a disease profile for the population segment, and the one or more clinical characteristics exhibited by the population segment.

Further, the data extraction processor 208 may extract the one or more influence factors and one or more population profiles corresponding to one or more clinical care pathway elements in the generic clinical care pathway report 402 in the received request. Further, the data extraction processor 208 generates one or more knowledge bases 408 based on the one or more influence factors and one or more population profiles extracted from one or more data sources 406.

Thereafter, the processor 202, after determining that an external medical ontology is not present, may segment each of the one or more compound statements in the one or more data sources into the plurality of statements. In an embodiment, the processor 202 may segment a compound statement, such as “Trans radial approach has been shown to be superior to the femoral approach in terms of reducing vascular access complications and improving patient comfort.” Thereafter the processor 202 may identify the noun phrases, such as “Trans radial approach,” and “the femoral approach in terms of reducing vascular access complications and improving patient comfort” in the parse tree of the plurality of statements corresponding to each of one or more compound statements.

Thereafter, the processor 202 may further prune the noun phrase when the original noun phrase comprises more than one child noun phrase. The pruning may generate noun phrases, such as “femoral approach,” “vascular access complications,” and “patient comfort” from the original noun phrase “femoral approach in terms of reducing vascular access complications and improving patient comfort.”

Further, the processor 202 may determine the relation between a first child noun phrase, i.e., a clinical care pathway element, and a second child noun phrase, i.e., influence factor. The processor 202 may further determine direction of the influence factor, for example, “Trans radial approach-superior,” “superior-femoral approach,” “reducing-vascular access complications,” and “improving-patient comfort.” Thereafter, the processor 202 may generate the structured tuple, such as “Trans radial approach; reducing-vascular access complications; femoral approach” and “Trans radial approach; Improving-patient comfort; femoral approach.” Accordingly, the processor 202 generates structured tuples, such as (Trans Radial approach; reducing; vascular access complications; femoral approach) and (Trans Radial approach; improving; patient comfort; femoral approach).

Further, the processor 202 may determine the polarity of the one or more influence factors. The data extraction processor 208 may identify and extract the one or more population profiles to which the one or more influence factors are applicable to. The processor 202 may utilize the one or more unsupervised techniques to extract the one or more population profiles. The processor 202 may anchor the presence of the one or more population profiles, indicated by a patient or population group (POPG), in the one or more compound statements in the one or more data sources.

Further, the processor 202 may compare the one or more factors associated with patient profile and population segment of the patient with the extracted one or more influence factors and the one or more population profiles, respectively, in the generated one or more knowledge bases.

Based on a comparison of the one or more factors in the population segment of the patient with the most suitable population profiles of a clinical care pathway element choice, the advisory information generation processor 210 may categorize the one or more clinical care pathway element choices, such as “Trans radial” and “Femoral” based on determination of the “positive” or “negative” of each of the one or more clinical care pathway element choices for the patient. For example, as the patient has a high potential bleeding risk, the advisory information generation processor 210 may categorize the “Trans radial” and “Femoral” choices as based on determination of the “positive” and “negative,” respectively. The medical practitioner validates the set of choices and the advisory information generation processor 210 generates a personalized clinical care pathway for the patient. The processor 202 may be configured to render the personalized advisory information on the display of the user-computing device 102.

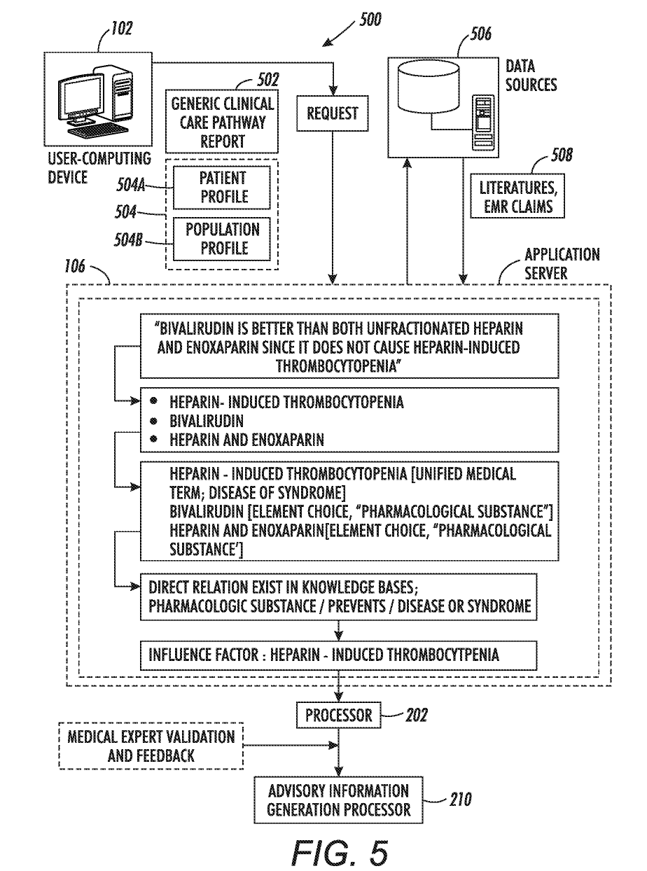

FIG. 5 is a block diagram that illustrates an exemplary scenario for generating personalized advisory information by semantic influence factor extraction method, in accordance with at least one embodiment. FIG. 5 is described in conjunction with FIG. 1 to FIG. 3C. With reference to FIG. 5, there is shown an exemplary scenario 500 for generating personalized advisory information for a patient by semantic influence factor extraction method.

With regard to the exemplary scenario 500, a user may request using a user-computing device 102 for processing the medical data of a patient. The request may include a generic clinical care pathway report 502 and the medical data 504 of the patient. Further, the request may include the patient profile 504A, that may include the one or more pre-existing diseases, current disease, remarks, current drug prescription for the current disease and a population segment, such as young, elderly, or diabetic, of the patient. Further, the population segment of the patient may comprise an age, a gender, a disease profile for the population segment, and the one or more clinical characteristics exhibited by the population segment.

Further, the data extraction processor 208 may extract the one or more influence factors and one or more population profiles corresponding to one or more clinical care pathway elements in the generic clinical care pathway report 502 in the received request. Further, the data extraction processor 208 generates one or more knowledge bases 408 based on the one or more influence factors and one or more population profiles extracted from one or more data sources 406.

Thereafter, the processor 202, after determining that an external medical ontology is present, may execute a UMLS metathesarus tool to extract the plurality of phrases, the one or more medical keywords, and the semantic types for each of the one or more compound statements, such as “Bivalirudin is better than both unfractionated Heparin and Enoxaparin since it does not cause Heparin-induced thrombocytopenia” in the one or more data sources. The plurality of phrases may include “Heparin-induced thrombocytopenia,” “Bivalirudin,” and “Heparin and Enoxaparin.”

Thereafter, the processor 202 may tag the phrase “Heparin-induced thrombocytopenia” with the unified medical term “Disease or Syndrome,” “Bivalirudin” with the clinical care pathway element choice “Pharmacological substance” and “Heparin-induced thrombocytopenia” with the clinical care pathway element choice “Pharmacological substance.”

After tagging, the processor 202 may determine a direct association between the clinical care pathway element and the tagged unified medical term in the external knowledge ontology as, “Pharmacologic substance|prevents|disease or syndrome” and consequently determines “Heparin-induced thrombocytopenia” as the influence factor.

Further, the processor 202 may compare the one or more factors associated with patient profile and population segment of the patient with the extracted influence factors and the one or more population profiles, respectively, in the generated one or more knowledge bases. Further, the processor 202 may determine the polarity of the influence factor. The data extraction processor 208 may identify and extract the one or more population profiles to which the one or more influence factors are applicable to. The processor 202 may utilize the one or more unsupervised techniques to extract the one or more population profiles. The processor 202 may anchor the presence of the one or more population profiles, indicated by a patient or population group (POPG), in the one or more compound statements in the one or more data sources.

Further, the processor 202 may compare the one or more factors associated with patient profile and population segment of the patient with the extracted influence factor and the one or more population profiles, respectively, in the generated one or more knowledge bases. Based on a comparison of the one or more factors in the population segment of the patient with the most suitable population profiles of a clinical care pathway element choice, the advisory information generation processor 210 may categorize the one or more clinical care pathway element choices, such as “Bivalirudin,” and “Heparin and Enoxaparin,” based on determination of the “positive” or “negative” of each of the one or more clinical care pathway element choices for the patient. For example, as the patient has a high score of superficial bleeding on the skin, the advisory information generation processor 210 may categorize the “Bivalirudin” and “Heparin and Enoxaparin” choices as “positive” and “negative,” respectively. The medical practitioner validates the set of choices and the advisory information generation processor 210 generates a personalized clinical care pathway for the patient. The processor 202 may be configured to render the personalized advisory information on the display of the user-computing device 102.

The disclosed embodiments encompass numerous advantages. The disclosure provides a method and a system for medical data processing for generating personalized advisory information by a computing server. The clinical care pathways are personalized based on patient and population specific factors, by mining the information contained in clinical outcomes research literature and by combining it with patient medical records and cost information. Accordingly, advisory information on the clinical care pathway element selection is provided to the medical practitioner interactively. The clinical care pathways are personalized for specific patient/population by automatically extracting the influence factors for clinical care pathway elements selection from clinical outcomes research literature and this extracted information is stored in a knowledge base of clinical care pathway elements. The presence of influence factors in patient's medical record are detected automatically by using the information from care pathway knowledge base. The user interface that renders the interactive advisory information helps the medical practitioner make an appropriate choice for the clinical care pathway element, taking into account current patient's profile and population specific factors.

The disclosed method may be utilized to provide a proper treatment to the patient in an efficient manner with the value-based payment model. The disclosed method minimizes clinical care pathways variations by evidences based on global best practices. Local adaptations in clinical care pathways are enables for personalized targeted therapy using patient and population specific factors to optimize outcome and reduce costs. Thus, an effective and enduring health outcome may be achieved at a reasonable cost to the patients.

The disclosed method may be further utilized to reduce the burden of judgment by the medical practitioner to advice the patient on the set of choices based on the patient specific factors. The disclosed method may be utilized to enable a medical practitioner to select the best choices for an element from the set of choices by considering the historical records of the patient under treatment. The disclosed method may be utilized to increase the profit of the health providers by ensuring an effective health outcome to the patients under treatment and reducing the penalties by ensuring low re-admission of the patient for the same or related diseases.

The disclosed method and system, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive, such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks, such as LAN, MAN, WAN, and the internet. The computer system facilitates input from a user through input devices accessible to the system through the I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The system and method described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic.” Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above method and system, or the numerous possible variations thereof.

Various embodiments of the method and system for medical data processing for generating personalized advisory information by a computing server have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person having ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for medical data processing for generating personalized advisory information by a computing server, said method comprising:
receiving, by one or more transceivers in said computing server, a request comprising a generic clinical care pathway report and medical data of a patient from a user-computing device over a communication network, wherein said medical data comprises one or more factors associated with a patient profile and a population segment of said patient;
extracting, by a data extraction processor in said computing server, one or more influence factors and one or more population segments, corresponding to one or more clinical care pathway elements in said generic clinical care pathway report in said received request, from one or more data sources based on a plurality of unsupervised data mining techniques to generate one or more knowledge bases;
comparing, by said one or more processors in said computing server, said one or more factors associated with said patient profile and said population segment of said patient with said extracted said one or more influence factors and said one or more population profiles in said generated one or more knowledge bases, respectively; and
generating, by an advisory information generation processor in said computing server, based on said comparison, a personalized advisory information comprising a set of choices for said one or more clinical care pathway elements automatically for said patient, wherein said determined set of choices in said personalized advisory information are rendered on an interactive user interface of said user-computing device over said communication network for selection by a medical practitioner.

2. The method of claim 1, wherein said patient profile comprises one or more pre-existing diseases, a current disease, one or more remarks, a current drug prescription for said current disease and a population segment of said patient.

3. The method of claim 1, wherein said population profile corresponds to an age of each of plurality of patients, a gender of each of said plurality of patients, a disease profile for said one or more population segments, and one or more clinical characteristics exhibited by said one or more population segments.

4. The method of claim 1 further comprising extracting, by said data extraction processor, said one or more influence factors by use of one or more techniques, wherein said one or more techniques are selected at least from a syntactic influence factor extraction technique, a semantic influence factor extraction technique, and a pattern extraction technique.

5. The method of claim 4, wherein said syntactic influence factor extraction technique further comprising:
segmenting, by said one or more processors, each of one or more compound statements in said one or more data sources into a plurality of statements based on one or more words, wherein said one or more compound statements are filtered to remove one or more characters;
identifying, by said one or more processors, a plurality of noun phrases in a parse tree of said set of statements corresponding to each of the one or more compound statements;
determining, by said one or more processors, a plurality child noun phrases of each of said identified plurality of noun phrases; and
determining, by said one or more processors, at least a relation between a first child noun phrase and a second child noun phrase of said plurality of child noun phrases, wherein said first child noun phrase corresponds to a clinical care pathway element and said second child noun phrase corresponds to an influence factor corresponding to said clinical care pathway element.

6. The method of claim 4, wherein said syntactic influence factor extraction technique further comprising generating, by said one or more processors, at least a structured tuple that includes a first choice corresponding to said clinical care pathway element, a direction of said influence factor from said first choice to a second choice corresponding to said clinical care pathway element, said influence factor of said first choice with respect to said second choice, and said second choice corresponding to said clinical care pathway element.

7. The method of claim 4, wherein said semantic influence factor extraction technique further comprising:
extracting, by said data extraction processor, a plurality of phrases, medical keywords, and semantic types from each of one or more compound statements in said one or more data sources;
tagging, by said one or more processors, each of said extracted plurality of phrases, medical keywords, and semantic types with corresponding unified medical terms;
identify, by said one or more processors, an association between a choice corresponding to said clinical care pathway element and a tagged unified medical terms; and
determining, by said one or more processors, said one or more influence factors based on said identified association and an external knowledge source.

8. The method of claim 7, wherein said identification of said association between said choice corresponding to said clinical care pathway element and said tagged unified medical terms is based on a direct relation or a transitive relation between said choice and said tagged unified medical term.

9. The method of claim 7, wherein said identification of said association between said choice corresponding to said clinical care pathway element and said tagged unified medical terms is based on a pattern extraction technique when said one or more influence factors correspond to non-unified medical term or said association between said choice corresponding to said clinical care pathway element and said tagged unified medical terms is based on multi-level transitive relation between said choice and said tagged unified medical term.

10. The method of claim 1 wherein said extraction of said one or more population segments further comprising:
tagging, by said one or more processors, a plurality of terms in one or more compound statements in said one or more data sources with a patient group or a population group; and
identifying, by said one or more processors, a maximal connected component anchored at said tagged plurality of terms for said extraction of said one or more population segments.

11. The method of claim 1 further comprising determining, by said one or more processors, a polarity of each of said one or more influence factors based on said type of influence on one or more choices corresponding to said clinical care pathway element, wherein said polarity of influence factor is one of a positive polarity or a negative polarity.

12. The method of claim 11, wherein a first choice from said set of choices in said personalized advisory information is categorized as a positive choice when said first choice negatively affects an influence factor with a negative polarity or positively affects an influence factor with a positive polarity.

13. The method of claim 11, wherein a second choice from said set of choices in said personalized advisory information is categorized as a negative choice when said second choice positively affects an influence factor with a negative polarity or negatively affects an influence factor with a positive polarity.

14. The method of claim 1, wherein said set of choices are validated by said medical practitioner using said interactive user interface of said user-computing device over said communication network.

15. A system for medical data processing for generating personalized advisory information by a computing server, said system comprising:
one or more transceivers in said computing server configured to:
receive a request comprising a generic clinical care pathway report and medical data of a patient from a user-computing device over a communication network, wherein said medical data comprises one or more factors associated with a patient profile and a population segment of said patient;
a data extraction processor in said computing server configured to:
extract one or more influence factors and one or more population segments, corresponding to one or more clinical care pathway elements in said generic clinical care pathway report in said received request, from one or more data sources based on a plurality of unsupervised data mining techniques to generate one or more knowledge bases;
one or more processors in said computing server configured to:
compare said one or more factors associated with said patient profile and said population segment of said patient with said extracted said one or more influence factors and said one or more population segments in said generated one or more knowledge bases, respectively; and
an advisory information generation processor in said computing server configured to:
generate based on said comparison, a personalized advisory information comprising a set of choices for said one or more clinical care pathway elements automatically for said patient, wherein said determined set of choices in said personalized advisory information are rendered on an interactive user interface of said user-computing device over said communication network for selection by a medical practitioner.

16. The system of claim 15, wherein said patient profile comprises one or more pre-existing diseases, a current disease, one or more remarks, a current drug prescription for said current disease and a population segment of said patient.

17. The system of claim 15, wherein said population profile corresponds to an age of each of plurality of patients, a gender of each of said plurality of patients, a disease profile for said one or more population segments, and one or more clinical characteristics exhibited by said one or more population segments.

18. The system of claim 15, wherein said one or more processors in said computing server are further configured to extract said one or more influence factors by use of one or more techniques, wherein said one or more techniques are selected at least from a syntactic influence factor extraction technique, a semantic influence factor extraction technique, and a pattern extraction technique.

19. The system of claim 18, wherein said syntactic influence factor extraction technique further comprising:
said one or more processors in said computing server configured to:
segment each of one or more compound statements in said one or more data sources into a plurality of statements based on one or more words, wherein said one or more compound statements are filtered to remove one or more characters;
identify a plurality of noun phrases in a parse tree of said set of statements corresponding to each of the one or more compound statements;
determine a plurality child noun phrases of each of said identified plurality of noun phrases; and
determine at least a relation between a first child noun phrase and a second child noun phrase of said plurality of child noun phrases, wherein said first child noun phrase corresponds to a clinical care pathway element and said second child noun phrase corresponds to an influence factor corresponding to said clinical care pathway element.

20. The system of claim 18, wherein said syntactic influence factor extraction technique further comprising:
said one or more processors in said computing server configured to:
generate at least a structured tuple that includes a first choice corresponding to said clinical care pathway element, a direction of said influence factor from said first choice to a second choice corresponding to said clinical care pathway element, said influence factor of said first choice with respect to said second choice, and said second choice corresponding to said clinical care pathway element.

21. The system of claim 18, wherein said semantic influence factor extraction technique further comprising:
said one or more processors in said computing server configured to:
extract a plurality of phrases, medical keywords, and semantic types from each of one or more compound statements in said one or more data sources;
tag each of said extracted plurality of phrases, medical keywords, and semantic types with corresponding unified medical terms;
identify an association between a choice corresponding to said clinical care pathway element and a tagged unified medical terms; and
determine said one or more influence factors based on said identified association and an external knowledge source.

22. The system of claim 21, wherein said identification of said association between said choice corresponding to said clinical care pathway element and said tagged unified medical terms is based on a direct relation or a transitive relation between said choice and said tagged unified medical term.

23. The system of claim 21, wherein said identification of said association between said choice corresponding to said clinical care pathway element and said tagged unified medical terms is based on a pattern extraction technique when said one or more influence factors correspond to non-unified medical term or said association between said choice corresponding to said clinical care pathway element and said tagged unified medical terms is based on multi-level transitive relation between said choice and said tagged unified medical term.

24. The system of claim 15 wherein said extraction of said one or more population segments further comprising:
said one or more processors in said computing server configured to:
tag a plurality of terms in one or more compound statements in said one or more data sources with a patient group or a population group; and
identify a maximal connected component anchored at said tagged plurality of terms for said extraction of said one or more population segments.

25. The system of claim 15, wherein said one or more processors at said computing server are further configured to determine a polarity of each of said one or more influence factors based on said type of influence on one or more choices corresponding to said clinical care pathway element, wherein said polarity of influence factor is one of a positive polarity or a negative polarity.

26. The system of claim 25, wherein a first choice from said set of choices in said personalized advisory information is categorized as a positive choice when said first choice negatively affects an influence factor with a negative polarity or positively affects an influence factor with a positive polarity.

27. The method of claim 25, wherein a second choice from said set of choices in said personalized advisory information is categorized as a negative choice when said second choice positively affects an influence factor with a negative polarity or negatively affects an influence factor with a positive polarity.

28. The system of claim 26, wherein said interactive user interface of said user-computing device is configured to enable said medical practitioner to validate said categorized set of choices.

29. A computer program product for use with a computer, said computer program product comprising a non-transitory computer readable medium, wherein said non-transitory computer readable medium stores a computer program code for medical data processing for generating personalized advisory information by a computing server, said computer program code is executable by:
one or more transceivers in a computing server to:
receive a request comprising a generic clinical care pathway report and medical data of a patient from a user-computing device over a communication network, wherein said medical data comprises one or more factors associated with a patient profile and a population segment of said patient;
one or more processors in said computing server to:
extract one or more influence factors and one or more population segments, corresponding to one or more clinical care pathway elements in said generic clinical care pathway report in said received request, from one or more data sources based on a plurality of unsupervised data mining techniques to generate one or more knowledge bases;
compare said one or more factors associated with said patient profile and said population segment of said patient with said extracted said one or more influence factors and said one or more population segments in said generated one or more knowledge bases, respectively; and
generate based on said comparison, a personalized advisory information comprising a set of choices for said one or more clinical care pathway elements automatically for said patient, wherein said determined set of choices in said personalized advisory information are rendered on an interactive user interface of said user-computing device over said communication network for selection by a medical practitioner.
